(19) United States
(12) Patent Application Publication
(10) Pub. No.: US 2004/0062059 A1
(43) Pub. Date: Apr. 1, 2004

(54) Apparatus and method employing bi-directional converter for charging and/or supplying power

(75) Inventors: Bing Cheng, West Bloomfield, MI (US); Fengtai Huang, Windsor (CA)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems Corporation, Dearborn, MI (US)

(21) Appl. No.: 10/622,845

(22) Filed: Jul. 18, 2003

Related U.S. Application Data
(60) Provisional application No. 60/397,469, filed on Jul. 19, 2002.

(51) Int. Cl. H02M 3/335

(52) U.S. Cl. 363/17

(57) ABSTRACT

A power system, such as an integrated power module comprising a bi-directional converter, functionally combines a power inverter and a charger such as a charger for charging one or more electrical storage devices such as batteries and/or super- or ultra-capacitors. A first switch selectively couples one or more AC devices to the bi-directional converter, and/or a second switch selectively couples a boosting circuit to one or more DC devices and/or reverses polarity of the coupling. The power system may have electric vehicle and/or vehicle-to-grid applications.

### BACKGROUND OF THE INVENTION

1. Field of the Invention

This disclosure generally relates to power supply systems employing a bi-directional power module, useful in a variety of applications including electric vehicles.

2. Description of the Related Art

As the U.S. population continues to move from the cities to the suburbs, and as major metropolitan areas continue to grow, so do traffic congestion, energy consumption, and air pollution problems. As a result of these environmental resource problems, more and more attention has been focused on the use of electric vehicles (EVs) in recent years. EVs may include, for example, battery-powered vehicles, fuel cell vehicles, and hybrid electric vehicles (HEVs). Several states, including California, New York, and others, have instituted programs and policies designed to encourage the development and use of electric drive and other low-pollution vehicles. The goal of these programs and policies is the reduction of energy consumption by, and air pollution from, mobile sources. One such initiative is the “vehicle-to-grid” (V2G) power initiative. The goal of the V2G power initiative is to couple EVs to a distributed grid such that the EVs may be used to generate peak and emergency electric power for use by other, usually land-based consumers such as businesses and homeowners.

FIG. 1 shows a conventional zero-emission, renewable energy EV typically includes a three-phase inverter 10 operable for receiving energy from an electrical storage device 12, such as one or more batteries and/or one or more ultra-capacitors, and/or from one or more fuel cells (not shown) and providing electric power to a motor 14, such as a permanent magnet motor, a switched-reluctance motor, a field-oriented induction motor, or the like. A charger 16 is used to charge the electrical storage device 12, as necessary. A conventional battery charger 16 typically includes a full-bridge rectifier 18 operable for converting a single/three-phase alternating-current (AC) voltage into a direct-current (DC) voltage. The battery charger 16 also includes a full-bridge DC/DC converter 20 operable for regulating the output voltage and current to the electrical storage device 12. The battery charger 16 further includes another rectifier 22 operable for rectifying the pulsed voltage into a DC voltage used to charge the electrical storage device 12. In a V2G power scheme, the three-phase inverter 10 and the battery charger 16 may be coupled to a single/three phase AC grid 24.

The conventional configuration described above results in an unused battery charger 16 when an EV is driving, and an unused three-phase inverter 10 when the electrical storage device 12 is charging. Because the battery charger 16 and the three-phase inverter 10 are separate, discrete components, this conventional configuration is also typically complex and bulky. The conventional configuration further has a relatively limited voltage range for the charging of an electrical storage device 12 and an uncontrollable input power factor. Thus, what is needed is an integrated power module, such as a single-stage bi-directional power module, combining the battery charger 16 and the three-phase inverter 10, at least functionally, such that the configuration is simple and compact. What is also needed is an integrated power module that has a relatively broad voltage range for the charging of an electrical storage device 12 and a controllable input power factor.

### BRIEF SUMMARY OF THE INVENTION

In some aspects, a power system, such as an integrated power module comprising a bi-directional converter, functionally combines a power inverter and a charger such as a charger for charging one or more electrical storage devices such as batteries and/or super- or ultra-capacitors. The single-stage bi-directional converter utilizes existing three-phase inverter hardware and, in effect, eliminates the conventional battery charger, resulting in a simple and compact integrated power module configuration that has a relatively broad voltage range for the charging. For example, the voltage range may be from about 0V to any predetermined maximum voltage (e.g., battery voltage). The power module may also have a controllable input power factor up to unity at charging and allows a battery or super- or ultra-capacitor to be charged with any utility AC power source, such as a single-phase source, a three-phase source, a 110Vac/220Vac source, or the like. The power module may further provide reduced harmonics during charging and ready availability for connection to a V2G power grid, such as that described above.

In one aspect, a power system to provide power between a DC device and at least one of a primary alternating current AC device and a secondary alternating current AC device comprises: a bi-directional power converter comprising a set of alternating current AC terminals, a set of DC terminals, and a number of bridge legs electrically couplable between the set of AC terminals and the set of DC terminals, at least some of the bridge legs selectively operable to invert a current when the current is flowing from the set of DC terminals to the set of AC terminals and to rectify the current when the current is flowing from the set of AC terminals to the set of DC terminals; and a first switch operable to selectively electrically couple and uncouple the secondary AC device respectively to and from the set of AC terminals of the bi-directional power converter. The power system may further comprise a second switch operable to selectively electrically reverse a polarity of a coupling of the DC device to the set of DC terminals. The power system may further comprise: a capacitor, an inductor and a diode electrically coupled to form a boosting circuit where the second switch operable to selectively electrically couple and uncouple the boosting circuit between the set of DC terminals of the bi-directional power converter and the DC device.

In another aspect, an integrated power module comprises: a bi-directional power converter comprising a first set of terminals and a second set of terminals, the bi-directional power converter selectively operable to invert a current when the current is flowing from the second set of terminals to the first set of terminals and to rectify the current when the current is flowing from the first set of terminals to the second set of terminals; and a first switch operable to selectively electrically couple and uncouple a first device respectively to and from the first set of terminals of the bi-directional power converter.

In yet another aspect, an integrated power module comprises: a bi-directional power converter comprising a first set of terminals and a second set of terminals, the bi-directional power converter selectively operable to invert a current when the current is flowing from the second set of terminals to the first set of terminals and to rectify the current when the current is flowing from the first set of terminals to the second set of terminals; and a first multi-positional switch operable to: in a first position, selectively electrically couple a first device to the first set of terminals of the bi-directional power converter and to selectively electrically uncouple a second device from the first set of terminals of the bi-directional power converter; and in a second position, selectively electrically uncouple the first device from the first set of terminals of the bi-directional power converter and to selectively electrically couple the second device to the first set of terminals of the bi-directional power converter.

In still another aspect, an integrated power module comprises: a bi-directional power converter comprising a first set of terminals and a second set of terminals, the bi-directional power converter selectively operable to invert a current when the current is flowing from the second set of terminals to the first set of terminals and to rectify the current when the current is flowing from the first set of terminals to the second set of terminals; a capacitor, an inductor and a diode electrically coupled as a boosting circuit; and a first multi-positional switch operable to: in a first position, electrically couple the boosting circuit to the second set of terminals of the bi-directional power converter, and in a second position, electrically uncouple the boosting circuit from the second set of terminals of the bi-directional power converter.

In a further aspect, a method of operating a power system, the power system comprising a first switch and a bi-directional power converter, the bi-directional power converter comprising a set of AC terminals, a set of DC terminals and a number of switching components electrically couplable between the set of AC terminals and the set of DC terminals comprises: operating the first switch to at least one of: electrically couple a secondary AC device to the set of AC terminals of the bi-directional power converter and electrically uncouple the secondary AC device from the set of AC terminals of the bi-directional power converter; and operating the bi-directional power converter to at least one of: rectify a current when the current is flowing from the set of AC terminals to the set of DC terminals bi-directional power converter and invert the current when the current is flowing from the set of DC terminals to the set of AC terminals of the bi-directional power converter.

In yet a further aspect, a method of operating a power system, the power system comprising a bi-directional power converter comprises: electrically coupling a first AC device to the bi-directional power converter; rectifying a charging AC current supplied by the first AC device to the bi-directional power converter to produce a charging DC current; charging a DC device electrically coupled to the bi-directional power converter using the charging DC current; electrically uncoupling the first AC device from the bi-directional power converter; inverting a discharging DC current supplied by the DC device to the bi-directional power converter to produce a discharging AC current; and supplying the discharging AC current to a second AC device.

Some aspects are particularly suitable to use in an electric vehicle (EV) including a battery or ultra-capacitor bank, an electric motor, and an integrated power module. In at least one configuration, the integrated power module is operated as a charger in a first mode for charging the battery or ultra-capacitor bank of the EV from an electrical power grid and/or from regenerative braking, and operated as a power inverter in a second mode for driving the motor of the EV. In at least one configuration, the integrated power module is operated as a charger in a first mode for charging the battery or ultra-capacitor bank of the EV and operated as a power inverter in a second mode for supplying power to a power grid in a V2G application.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a circuit diagram of a conventional electric vehicle (EV) power system having a separate, discrete battery charger and a power inverter.

FIG. 2 is a circuit diagram a bi-directional power module according to one illustrated embodiment, comprising an AC switch, a bi-directional converter, and a DC switch, the bi-directional power module combining a charger and the power inverter.

FIG. 3 is a circuit diagram illustrating two configurations of the bi-directional power module of FIG. 2, that electrically couple an inductor, capacitor, and diode to the bi-directional converter as a boost circuit.

FIG. 4 is a circuit diagram illustrating two of the configurations of the bi-directional power module of FIG. 2, operating in a boost converter configuration.

FIG. 5 is a circuit diagram illustrating the bi-directional power module of FIG. 2, operating in a buck-boost configuration as a battery charger.

FIG. 6 is a circuit diagram illustrating an equivalent circuit for the buck-boost converter configuration of FIG. 5.

FIG. 7 is a circuit diagram illustrating the bi-directional power module of FIG. 2, operating as a boost rectifier for charging an electrical storage device such as one or more batteries and/or super- or ultra-capacitors.

FIG. 8 is a circuit diagram illustrating an equivalent circuit of the bi-directional power module of FIG. 2, configured as an inverter.

### DETAILED DESCRIPTION OF THE INVENTION

In the following description, certain specific details are set forth in order to provide a thorough understanding of various embodiments of the power systems, integrated power modules and methods. However, one skilled in the art will understand that the invention may be practiced without these details. In other instances, well-known structures associated with inverters, rectifiers, converters, switches such as transistors, relays, contactors and the like, electric motors, fuel cell systems, electrical storage devices such as batteries and ultracapacitors, and controllers such as microprocessors, have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment of the present power systems, integrated power modules and methods. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the claimed invention.

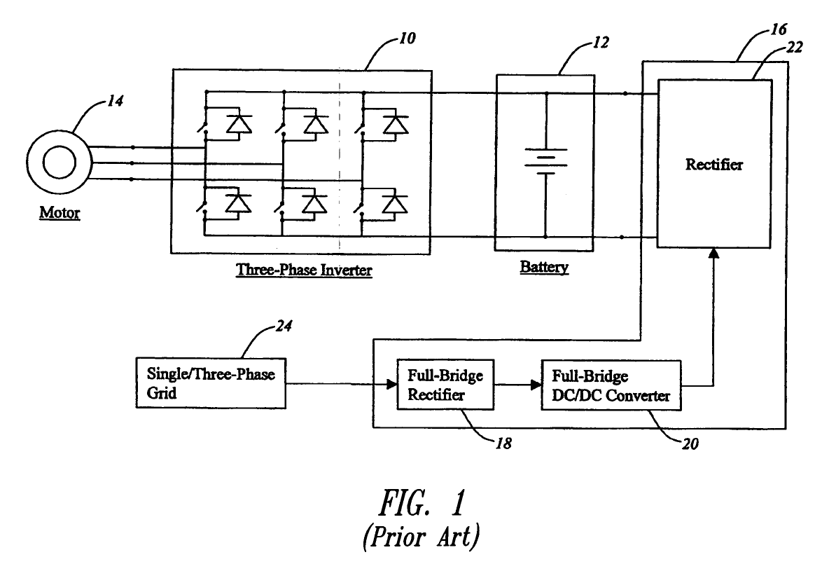

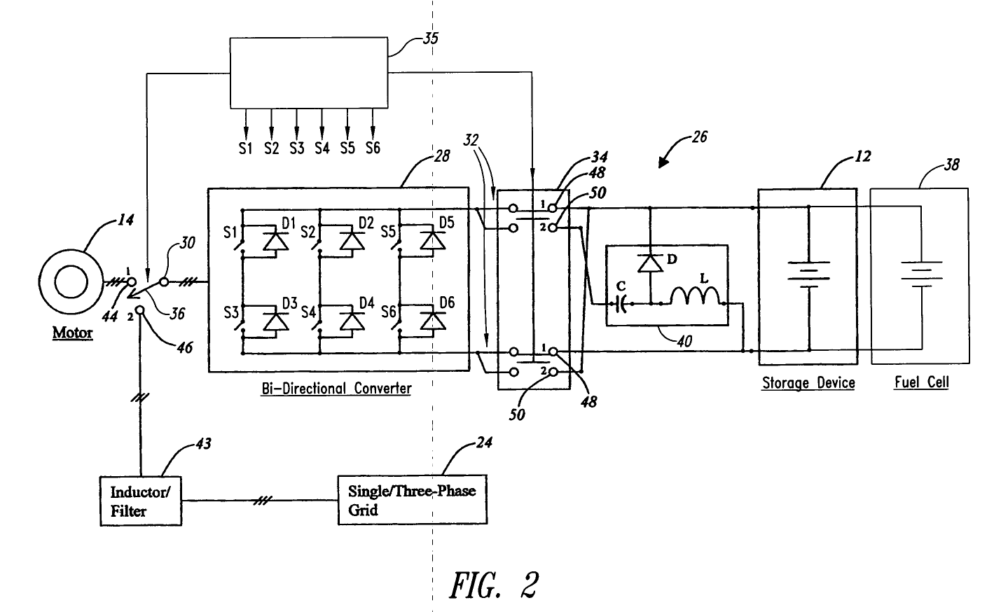

FIG. 2 shows one embodiment of a single-stage bi-directional power module 26 serving as both an electrical storage device charger 16 (FIG. 1) and a three-phase inverter 10 (FIG. 1). The single-stage bi-directional power module 26 includes a bi-directional power converter 28. The bi-directional power converter 28 comprises a first set of terminals (referred to as AC terminals) 30, a second set of terminals (referred to as DC terminals) 32, three pairs of legs formed by switches S1-S6 and diodes D1-D6, and a controller 35 coupled to provide control signals for operating the various switches either directly or via a gate drive (not shown). The controller 35 can control the switches S1-S6 to operate the bi-directional power converter 28 as an DC/AC converter (i.e., a three-phase inverter) and as a AC/DC converter (i.e., rectifier).

The switches S1-S6 typically take the form of one or more integrated gate bipolar transistors (IGBTs) or metal-oxide semiconductor field effect transistors (MOSFETs) with respective diodes electrically coupled in parallel across the switches. One skilled in the art will recognize that the bi-directional power module 26 may employ one or more single phase DC/AC converters (i.e., single phase inverters), or may operate the bi-directional power converter 28 as a single-phase inverter where suitable.

A switch (referred to as DC switch) 34 allows the single-stage bi-directional power module 26 to be switched between electrical storage device charger operation and power inverter operation via the DC terminals 32. As used herein and in the claims, the term switch refers to one or more switches. The DC switch 34 may be operable via control signals from the controller 35. In particular, the DC switch 34 may take the form of a double-pole double-through (DPDT) switch, although one skilled in the art will recognize that bi-directional power module 26 may employ one or more various other switches, relays, contactors and/or transistors such as bipolar insulated gate transistors (IGBTs) or metal-oxide semiconductor field effect transistors (MOSFETs) as DC switch 34.

A switch (referred to as AC switch) 36 allows the bi-directional power converter 28 to be electrically coupled to one or more AC devices via the AC terminals 30. The AC switch 36 may be operable via control signals from the controller 35. The AC switch 36 may take the form of a triple-pole double-through (TPDT) switch, although one skilled in the art will recognize that bi-directional power module 26 may employ one or more various other switches, relays, contactors and/or transistors such as IGBTs or MOSFETs as AC switch 36.

The AC switch 36 can provide a variety of functions. For example, operation of the AC switch 36 may electrically couple and uncouple an AC device such as an electrical power grid 24 (e.g., three phase or single phase) respectively to and from the bi-directional power module 26. Thus, where the bi-directional power module 26 is part of an electric vehicle (EV), the AC switch 36 may couple the bi-directional power converter 28 to the power grid 24 to allow charging of the electrical storage device 12 (e.g., one or more batteries and/or super- or ultra-capacitors), or to allow the bi-directional power converter 28 to supply power to the grid 24 in a vehicle-to-grid (V2G) application. In such an application, the bi-directional power converter 28 may supply power from a fuel cell system 38 or other power producing source and/or from the electrical storage device 12.

While the fuel cell system 38 is illustrated coupled in series with the electrical storage device 12, the DC switch 36 may also allow the selection between multiple DC devices (e.g., two banks of batteries, two banks of super- or ultra-capacitors, two or more fuel cell stacks of one or more fuel cell systems, or any combination of the above).

Operation of the AC switch 36 may also effect the electrical coupling of other AC devices, such as the AC motor 14 which may, for example, take the form of an AC traction motor, compressor motor and/or pump motor. For example, the AC switch 36 may electrically uncouple the AC motor 14 from the three-phase bi-directional power converter 28 when the power grid 24 is coupled to the bi-directional power converter 28, and may electrically couple the AC motor 14 to the three-phase bi-directional power converter 28 when the power grid 24 is electrically uncoupled from the bi-directional power converter 28.

Additionally, or alternatively, operation of the AC switch 36 may adjust a speed, frequency of, and/or power supplied to the additional AC devices such as AC motor 14. For example, operation of AC switch 36 may reduce the frequency of a traction motor, compressor motor and/or pump motor when the three-phase bi-directional power converter 28 is coupled to a secondary load such as the power grid 24. Conversely, operation of AC switch 36 may increase the frequency of a traction motor, compressor motor and/or pump motor when the three-phase bi-directional power converter 28 is coupled to a primary load such as the AC motor 14. Such operation may, for example, permit the fuel cell system 38 to continually operate, supplying electrical power to the power grid 24 when not powering a primary load. In some embodiments, the traction motor may not be electrically uncoupled from the bi-directional power converter 28 but simply operated at a lower frequency and power, particularly where compressors and/or pumps of the fuel cell system 38 are driven by the traction motor.

The bi-directional power module 26 may further include an inductor L, a capacitor C, and a diode D, collectively referred to as the “boosting” circuit 40 since in at least some embodiments the circuit boosts voltage in conjunction with the switches of the bi-directional power converter 28. The boosting circuit 40 extends the operational voltage range for the charging of an electrical storage device 12. The single-stage bi-directional power module 26 may also include an inductor/filter 43 disposed between AC switch 36 and the power grid 24.

Integrating the DC switch 34, the AC switch 36, and/or boosting circuit 40 into the bi-directional power module 26 provides a compact, cost efficient solution that may reduce inductance and noise associated with conventional approaches to systems employing AC and DC devices.

As illustrated in FIG. 2, AC switch 36 and DC switch 34 each have two (2) positions, thus the illustrated single-stage bi-directional power module 26 has four (4) possible physical configurations. Since current may flow both towards and away from the electrical storage device 12, there are two possible modes of operation for each configuration, for a total of eight possible modes of operation.

In configuration 1, the AC switch 36 is in position one 44, electrically coupling a primary AC device (e.g., motor 14) to the bi-directional power converter 28, and the DC switch 34 is in position one 48 electrically coupling the DC device(s) (e.g., electrical storage device 12 and/or fuel cell system 38) to the bi-directional power converter 28 with a first polarity.

In an operating mode A, the bi-directional power converter 28 of the single-stage bi-directional power module 26 is operated as an inverter to provide power to the motor 14 from one of the DC devices (e.g., electrical storage device 12 and/or fuel cell 38). The bi-directional power module 26 is operable as a buck converter to lower an output voltage where desirable. Mode A may, for example, correspond to an EV driving mode, where the bi-directional power module 26 is incorporated in an EV vehicle to power a traction, compressor and/or pump motor.

In an operating mode B, the bi-directional power converter 28 of the single-stage bi-directional power module 26 is operated as a rectifier to provide power to the electrical storage device 12 from the motor 14. The bi-directional power module 26 is operable as a buck converter to lower an output voltage where desirable. Mode B may, for example, correspond to a regeneration mode, such as EV regeneration during braking of an EV. However, configuration 1 lacks the ability to boost the charging DC current supplied to the electrical storage device 12 in mode B, so may have limited application when compared with other configurations and modes discussed below.

In configuration 2, the AC switch 36 is in position two 46, electrically coupling a secondary AC device (e.g., electrical power grid 24, other AC motors or loads such as lighting, heating or equipment loads) to the bi-directional power converter 28, and the DC switch 34 is in position one 48, electrically coupling the DC device(s) (e.g., electrical storage device 12 and/or fuel cell system 38) to the bi-directional power converter 28 with the first polarity.

In an operating mode A, the bi-directional power converter 28 of the single-stage bi-directional power module 26 is operated as an inverter to provide power to the power grid 24 from one or more of the DC devices (e.g., electrical storage device 12 and/or fuel cell system 38). The bi-directional power module 26 is operable as a buck converter to lower an output voltage where desirable. Mode A may, for example, correspond to a V2G application, where the bi-directional power module 26 is incorporated in an EV and supplies power to the power grid 24, for example during peak demand and/or while the EV is not being driven. As discussed above, in some embodiments the AC switch 36 leaves the motor 14 (e.g., traction, compressor and/or pump motor) electrically coupled to the bi-directional power converter 28 to operate the fuel cell system 38. In such an embodiment, the load on the motor 14 may be decreased, for example, by operating at a lower frequency, torque and/or power.

In an operating mode B, the bi-directional power converter 28 of the single-stage bi-directional power module 26 is operated as a rectifier to provide power to the electrical storage device 12 from the power grid 24. The bi-directional power module 26 is operable as a buck converter to lower an output voltage where desirable. Mode B may correspond to a battery recharging mode for an EV, for example, when the EV is parked and plugged into or otherwise connected to an electrical receptacle. electrically coupling the single-stage bi-directional power module 26 is configured for the charging of the electrical storage device 12 in a boost sub-configuration, allowing the single-stage bi-directional power module 26 to be operated as a voltage booster.

In configuration 3, the AC switch 36 is in position one 44, electrically coupling a primary AC device (e.g., motor 14) to the bi-directional power converter 28, and the DC switch 34 is in position two 50, electrically coupling one or more of the DC device(s) (e.g., electrical storage device 12 and/or fuel cell system 38) to the bi-directional power converter 28 via the boosting circuit 40 with a second polarity, opposite the first polarity.

In an operating mode A, the bi-directional power converter 28 of the single-stage bi-directional power module 26 is operated as an inverter to provide power to the primary AC device (e.g., motor 14) from one of the DC devices (e.g., electrical storage device 12 and/or fuel cell 38). The bi-directional power module 26 is operable as a buck converter to lower an output voltage where desirable.

In an operating mode B, the bi-directional power converter 28 of the single-stage bi-directional power module 26 is operated as a rectifier to provide power to the electrical storage device 12 from the primary AC device (e.g., motor 14). The bi-directional power module 26 is operable as a buck converter to lower an output voltage where desirable. Operating mode B may correspond to a regeneration application, recharging the electrical storage device 12 from power produced by operating the motor 14 as a generator, for example during braking. In contrast to an embodiment of configuration 1, configuration 3 provides boost capability. Thus, the embodiment of configuration may be more suitable for producing power during low speed braking, where the embodiment of configuration 1 may only be suitable for high speed breaking conditions, depending on a variety of factors such as the particular voltage ratings of the various components.

In configuration 4, the AC switch 36 is in position two 46, electrically coupling a secondary AC device (e.g., electrical power grid 24, other AC motors or loads such as lighting, heating or equipment loads) to the bi-directional power converter 28, and the DC switch 34 is in position two 50, electrically coupling the DC device(s) (e.g., electrical storage device 12 and/or fuel cell system 38) to the bi-directional power converter 28 via the boosting circuit 40 with the second polarity.

In an operating mode A, the bi-directional power converter 28 of the single-stage bi-directional power module 26 is operated as an inverter to provide power to the power grid 24 from one of the DC devices (e.g., electrical storage device 12 and/or fuel cell 38). The bi-directional power module 26 is operable as a buck converter to lower an output voltage where desirable. Operating mode A may, for example, correspond to a V2G application.

In an operating mode B, bi-directional power converter 28 of the single-stage bi-directional power module 26 is operated as a rectifier to provide power to the electrical storage device 12 from the power grid 24. The bi-directional power module 26 is operable as a buck converter to lower an output voltage where desirable. Operating mode B may correspond to a charging of the electrical storage device 12 in a buck-boost sub-configuration, allowing the single-stage bi-directional power module 26 to be operated as a buck-boost converter.

The selection of configurations 2 or 4 (mode B) will typically depend upon the charge-state of the electrical storage device 12 and the amount of time allowed for battery charging. Advantageously, the single-stage bi-directional power module 26 of the present power systems, integrated power modules and methods may also be operated as a peak power supply unit (e.g., mode A of configurations 2 and 4) or as an emergency power backup (e.g. UPS) unit (e.g., mode A of configurations 1 and 2).

In one embodiment, a method for switching from EV driving operation to battery charging operation includes switching DC switch 34 from position one 48 to position two 50. Almost immediately after this is completed, the capacitor C charges to the same voltage level as the electrical storage device 12. At this point, the bi-directional power converter 28 is in a blocking state. Once the capacitor C is fully charged, AC switch 36 is switched from position one 44 to position two 46.

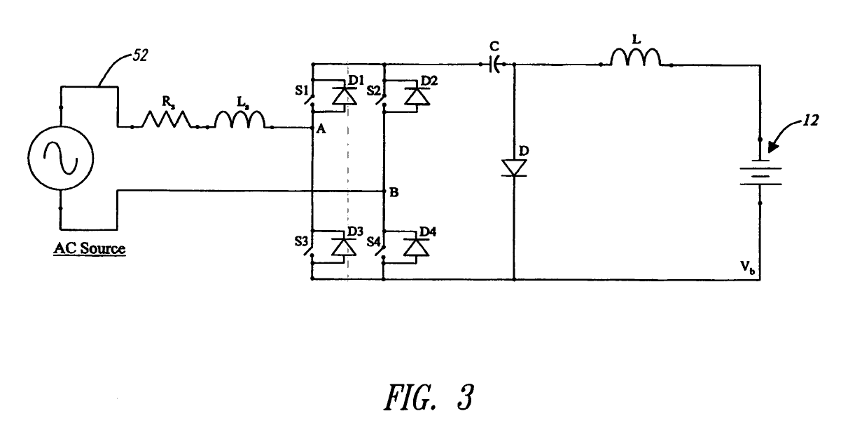

FIG. 3 shows the embodiment of configurations 3 and 4, mode B, assuming a single phase AC source 52 (e.g., power grid 24 and/or motor 14 operating in regeneration mode). As is clear to those of ordinary skill in the art, similar principles apply to a three-phase system. FIG. 3 and the figures that follow, omit certain structures and elements that were illustrated in FIG. 2, for the sake of clarity of presentation.

The capacitor C is charged to the sum of the peak AC voltage and the battery voltage. The charging voltage across capacitor C is expressed by the following equation:

V_{C}=(L_{S}+L)di/dt+V_{b}+Vₚ sin ωt, (1)

where V_{b} is the voltage across the electrical storage device 12 and Vₚ sin ωt is the AC source voltage. The maximum voltage of charged capacitor C is expressed by the following equation:

V_{C}=V^{b}+Vₚ, (2)

where Vₚ is the peak AC source voltage.

Once capacitor C is fully charged, the system is in a floating state and no charging current flows to the electrical storage device 12 until switches S1, S2, S3, and S4 are actuated. The switches S1, S2, S3, S4 may be actuated individually, in pairs, or all at the same time. Depending upon the switch configuration, three charging stages may exist.

The first charging stage is a boost stage. During the boost stage, the switches S1, S2, S3, S4 are actuated individually or in cross-pairs. The voltage across capacitor C is boosted to a level that is greater than V_{b}+Vₚ. For example, if the potential at point A is greater than at point B, either switch S2 or switch S3, or both, may be controlled using a pulse-width modulation (PWM) scheme, and the voltage across capacitor C is boosted. The amplitude is determined by the duty ratio and the value of inductor Lₛ. When switch S2 or switch S3, or both, are closed, the current through inductor Lₛ is increased through diode D1 or diode D4, or both. When switch S2 or switch S3, or both, are open, the induced voltage, Lₛ(di/dt), across inductor Lₛ, together with the AC source voltage and the voltage (e.g., V_{b}) across the electrical storage device 12, is applied to capacitor C. Similarly, if the potential at point B is greater than at point A, either switch S1 or switch S4, or both, may be controlled using a PWM scheme.

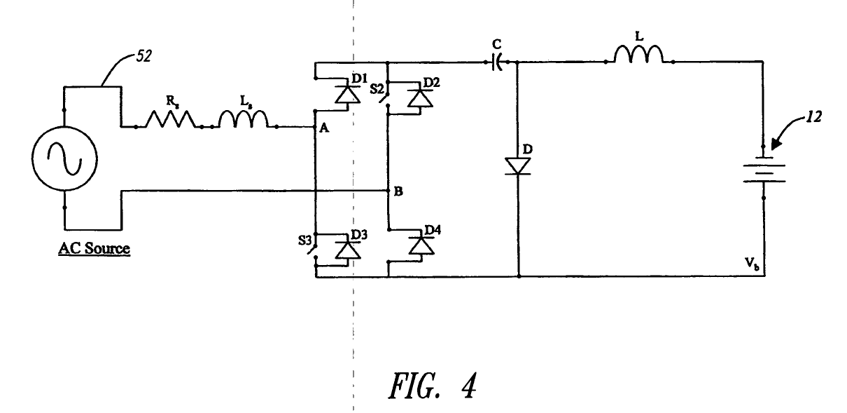

FIG. 4 illustrates a boost converter wherein switch S2 and switch S3 are actuated. The PWM scheme not only boosts the voltage across capacitor C, but also controls the shape of the input current or the input power factor.

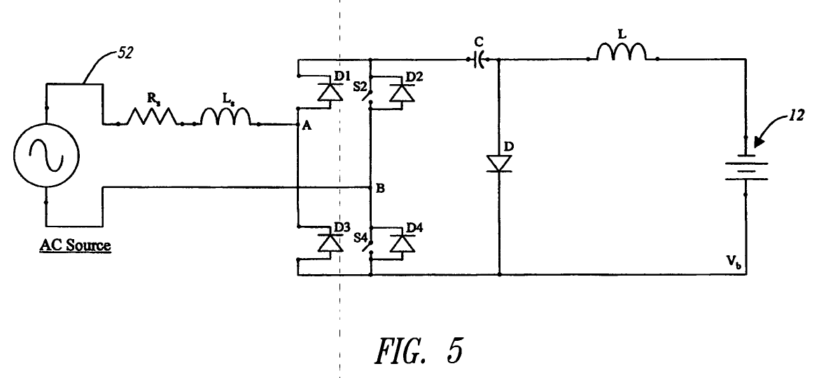

FIG. 5 illustrates the second charging stage as a buck-boost stage. During this stage, switches S1, S2, S3, and S4 are actuated in vertical pairs. The voltage across capacitor C is controlled to a predetermined level and the electrical storage device 12 is charged to a predetermined level according to a preprogrammed algorithm. For example, either switch S1 and switch S3 or switch S2 and switch S4 may be actuated. In particular, FIG. 5 illustrates the buck-boost converter where switches S2 and S4 are actuated. Switches that are not being actuated (S1 and S3 in this illustration) are omitted from this and the following figures. As used herein, “actuated” means actively being switched or controlled, whether instantaneously in an ON or OFF state.

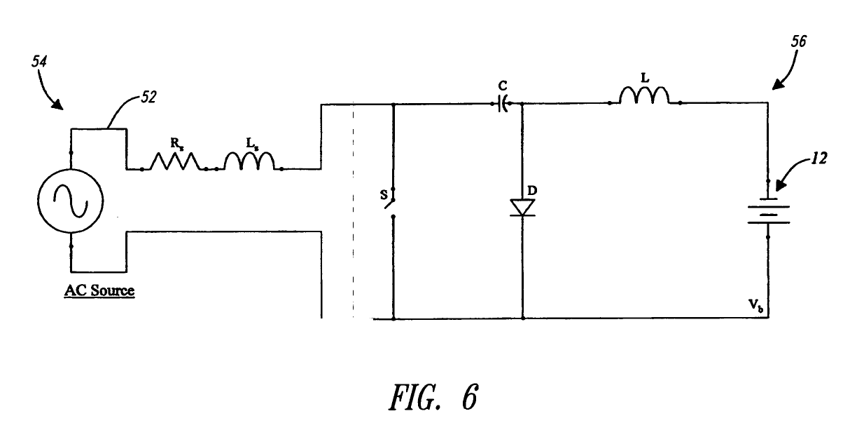

Referring to FIG. 6, in an equivalent circuit, it is clear to those of ordinary skill in the art that the left-half 54 of the circuit is a boost converter and the right-half 56 of the circuit is a buck converter. Both the boost converter and the buck converter share the same switch S. When switch S is closed, current through inductor Lₛ in the boost converter builds up, while energy stored in capacitor C discharges to the electrical storage device 12. When switch S is open, capacitor C is charged to the sum of the induced voltage across inductor Lₛ, the AC source voltage, and the voltage of the electrical storage device 12. The energy stored in inductor L while switch S is switched ON is discharged to the electrical storage device 12 through diode D when switch S is switched OFF.

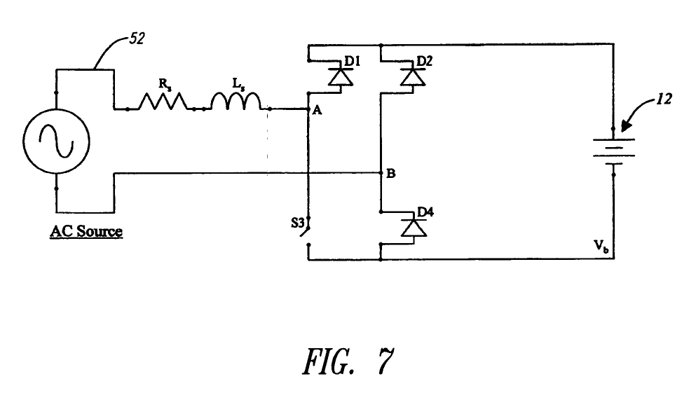

The two charging stages described above both occur in configuration 4, AC switch 36—position two 46 and DC switch 34—position two 50 (FIG. 2). The third charging stage occurs in configuration 2, AC switch 36—position two 46 and DC switch 34—position one 48 (FIG. 2). In configuration 2, the bi-directional power converter 28 may be operated as an ordinary boost rectifier, charging the electrical storage device 12 with the inductor L, capacitor C, and diode D cut out of the circuit. For example, referring to FIG. 7, if the potential at point A is greater than at point B, switch S3 is actuated. When switch S3 is closed, the current through inductor Lₛ builds up through switch S3 and diode D4 while the electrical storage device 12 is blocked by diode D1. When switch S3 is open, the induced voltage across inductor Lₛ and the AC source voltage are applied to the electrical storage device 12 through diode D1 and diode D4. Similar operation may occur when the potential at point B is greater than at point A.

Thus, the integrated power module 26 (FIG. 2) of the present power systems, integrated power modules and methods may be operated as a charger (e.g., battery charger) through three stages in at least two configurations. Stage selection is dependent upon the state of charge of the electrical storage device 12, the required charging time, and the utility voltage (110V/220V). Advantageously, the integrated power module 26 of the present power systems, integrated power modules and methods maximizes usage of an EV and extends the life cycle of the electrical storage device 12.

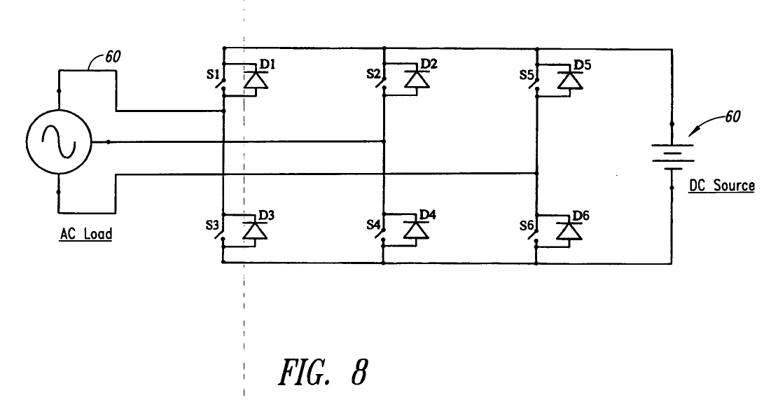

FIG. 8 shows an equivalent circuit corresponding to the embodiments of configurations 1 and 2, mode A, assuming a three phase AC load 58 (e.g., power grid 24 and/or motor 14) and a DC source 60 (e.g., electric storage device 12 and/or fuel cell system 38). As is clear to those of ordinary skill in the art, similar principles apply to a single phase system. FIG. 3, and the figures that follow, omit certain structures and elements that were illustrated in FIG. 2, for the sake of clarity of presentation. One or more of the switches S1-S6 are activated to are produce three phase AC output from the DC input, as is commonly known in the art.

Although specific embodiments of and examples for power system and method are described herein for illustrative purposes, various equivalent modifications can be made without departing from the spirit and scope of the invention, as will be recognized by those skilled in the relevant art. The teachings provided herein of the invention can be applied to other power systems, not necessarily the exemplary three phase inverter based power system generally described above. For example, the teachings may be applied to a single phase inverter based system.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to U.S. provisional patent application Serial No. 60/397,469, filed Jul. 19, 2002 and entitled “INTEGRATED POWER MODULE COMBINING A BATTERY CHARGER AND A POWER INVERTER” are incorporated herein by reference, in their entirety. Aspects of the invention can be modified, if necessary, to employ systems, circuits and concepts of the various patents, applications and publications to provide yet further embodiments of the invention.

These and other changes can be made to the invention in light of the above-detailed description. In general, in the following claims, the terms used should not be construed to limit the invention to the specific embodiments disclosed in the specification and the claims. Accordingly, the invention is not limited by the disclosure, but instead its scope is to be determined entirely by the following claims.

1. A power system to provide power between a DC device and at least one of a primary alternating current AC device and a secondary alternating current AC device, the power system comprising:
a bi-directional power converter comprising a set of alternating current AC terminals, a set of DC terminals, and a number of bridge legs electrically couplable between the set of AC terminals and the set of DC terminals, at least some of the bridge legs selectively operable to invert a current when the current is flowing from the set of DC terminals to the set of AC terminals and to rectify the current when the current is flowing from the set of AC terminals to the set of DC terminals; and
a first switch operable to selectively electrically couple and uncouple the secondary AC device respectively to and from the set of AC terminals of the bi-directional power converter.

2. The power system of claim 1, further comprising:
a second switch operable to selectively electrically reverse a polarity of a coupling of the DC device to the set of DC terminals.

3. The power system of claim 1, further comprising:
a capacitor;
an inductor;
a diode, wherein the capacitor, the inductor and the diode are electrically coupled with at least one switch of at least one of the bridge legs to form a boosting circuit; and
a second switch operable to selectively electrically couple and uncouple the boosting circuit between the set of DC terminals of the bi-directional power converter and the DC device.

4. The power system of claim 1 wherein the first switch is further operable to uncouple the primary AC device from the set of AC terminals of the bi-directional power converter when the secondary AC device is coupled to the set of AC terminals of the bi-directional power converter and to couple the AC primary device to the set of AC terminals of the bi-directional power converter when the secondary AC device is uncoupled from the set of AC terminals of the bi-directional power converter.

5. The power system of claim 1 wherein the first switch is a multi-positional switch operable to uncouple the primary AC device from the set of AC terminals of the bi-directional power converter when the secondary AC device is coupled to the set of AC terminals of the bi-directional power converter and to couple the primary AC device to the set of AC terminals of the bi-directional power converter when the secondary AC device is uncoupled from the set of AC terminals of the bi-directional power converter.

6. The power system of claim 1 wherein the first switch is a multi-positional relay operable to uncouple the primary AC device from the set of AC terminals of the bi-directional power converter when the secondary AC device is coupled to the set of AC terminals of the bi-directional power converter and to couple the primary AC device to the set of AC terminals of the bi-directional power converter when the secondary AC device is uncoupled from the set of AC terminals of the bi-directional power converter.

7. The power system of claim 1 wherein the first switch comprises at least a first switch element and a second switch element, the first switch element operable to couple and uncouple a first pole of the secondary AC device from a first pole of the set of AC terminals and the second switch element operable to couple and uncouple a second pole of the secondary AC device to a second pole of the set of AC terminals.

8. The power system of claim 1 wherein the first switch is further operable to the operate the primary AC device at low power level when the secondary AC device is coupled to the set of AC terminals of the bi-directional power converter.

9. The power system of claim 1 wherein the first switch is further operable to cause a physical load driven by the primary AC device to be uncoupled from the primary AC device when the secondary AC device is electrically coupled to the set of AC terminals of the bi-directional power converter and to cause the physical load driven by the primary AC device to be coupled to the primary AC device when the secondary AC device is electrically uncoupled to the set of AC terminals of the bi-directional power converter.

10. The power system of claim 1 wherein each of the bridge legs comprises a number of integrated bipolar junction transistors and a number of free-wheeling diodes electrically coupled across respective ones of the integrated bipolar junction transistors.

11. The power system of claim 1 wherein each of the bridge legs comprises a number of metal-oxide semiconductor field effect transistors and a number of free-wheeling diodes electrically coupled across respective ones of the metal-oxide semiconductor field effect transistors.

12. The power system of claim 1, further comprising:
at least one of the primary AC device; and the secondary AC device.

13. An integrated power module, comprising:
a bi-directional power converter comprising a first set of terminals and a second set of terminals, the bi-directional power converter selectively operable to invert a current when the current is flowing from the second set of terminals to the first set of terminals and to rectify the current when the current is flowing from the first set of terminals to the second set of terminals; and
a first switch operable to selectively electrically couple and uncouple a first device respectively to and from the first set of terminals of the bi-directional power converter.

14. The integrated power module of claim 13 wherein the first switch is further operable to selectively electrically uncouple a second device to the first set of terminals of the bi-directional power converter when the first device is coupled to the first set of terminals and to couple the first device to the first set of terminals when the second device is uncoupled from the first set of terminals.

15. The integrated power module of claim 13 wherein the first switch is further operable to selectively operate a second device at a first frequency when the first device is coupled to the first set of terminals of the bi-directional power converter and to operate the second device at a second frequency when the first device is uncoupled from the first set of terminals wherein the first frequency is less than the second frequency.

16. The integrated power module of claim 13, further comprising:
a second switch operable to selectively electrically reverse a polarity of a coupling of the second set of terminals of the bi-directional power converter.

17. The integrated power module of claim 16, further comprising:
a capacitor;
an inductor;
a diode, wherein the capacitor, the inductor and the diode are electrically coupled to form a boosting circuit with at least one switch of the bi-directional power converter; and
a second switch operable to selectively electrically couple the boosting circuit between the second set of terminals of the bi-directional power converter.

18. An integrated power module, comprising:
a bi-directional power converter comprising a first set of terminals and a second set of terminals, the bi-directional power converter selectively operable to invert a current when the current is flowing from the second set of terminals to the first set of terminals and to rectify the current when the current is flowing from the first set of terminals to the second set of terminals; and
a first multi-positional switch operable to:
in a first position, selectively electrically couple a first device to the first set of terminals of the bi-directional power converter and to selectively electrically uncouple a second device from the first set of terminals of the bi-directional power converter; and
in a second position, selectively electrically uncouple the first device from the first set of terminals of the bi-directional power converter and to selectively electrically couple the second device to the first set of terminals of the bi-directional power converter.

19. The integrated power module of claim 18, further comprising:
a second switch operable to selectively electrically reverse a polarity of a coupling of a third device to the second set of terminals of the bi-directional power converter.

20. The integrated power module of claim 19, further comprising:
a capacitor;
an inductor electrically coupled in series to the capacitor;
a diode electrically coupled to a node between the capacitor and the inductor, the capacitor, the inductor and the diode forming a boosting circuit with at least one switch of the bi-directional power converter; and
a second switch operable to selectively electrically couple the boosting circuit between the second set of terminals of the bi-directional power converter and a third device electrically coupled to the bi-directional power converter.

21. An integrated power module, comprising:
a bi-directional power converter comprising a first set of terminals and a second set of terminals, the bi-directional power converter selectively operable to invert a current when the current is flowing from the second set of terminals to the first set of terminals and to rectify the current when the current is flowing from the first set of terminals to the second set of terminals;
a capacitor, an inductor and a diode electrically coupled with at least one switch of the bi-directional power converter as a boosting circuit; and
a first multi-positional switch operable to:
in a first position, electrically couple the boosting circuit to the second set of terminals of the bi-directional power converter, and
in a second position, electrically uncouple the boosting circuit from the second set of terminals of the bi-directional power converter.

22. The integrated power module of claim 21 wherein the first multi-positional switch is further operable to reverse a polarity of a coupling of the second set of terminals to at least a first DC device through the boosting circuit.

23. The integrated power module of claim 21 wherein the first multi-positional switch electrically couples the boosting circuit to the second set of terminals of the bi-directional power converter when current is flowing from the first set of terminals to the second set of terminals and electrically uncouples the boosting circuit from the second set of terminals of the bi-directional power converter when current is flowing from the second set of terminals to the first set of terminals.

24. A method of operating a power system, the power system comprising a first switch and a bi-directional power converter, the bi-directional power converter comprising a set of AC terminals, a set of DC terminals and a number of switching components electrically couplable between the set of AC terminals and the set of DC terminals, the method comprising:
operating the first switch to at least one of: electrically couple a secondary AC device to the set of AC terminals of the bi-directional power converter and electrically uncouple the secondary AC device from the set of AC terminals of the bi-directional power converter; and
operating the bi-directional power converter to at least one of: rectify a current when the current is flowing from the set of AC terminals to the set of DC terminals bi-directional power converter and invert the current when the current is flowing from the set of DC terminals to the set of AC terminals of the bi-directional power converter.

25. The method of claim 24 wherein operating the first switch to electrically couple the secondary AC device to the set of AC terminals of the bi-directional power converter further electrically uncouples a primary AC device from the first set of AC terminals of the bi-directional power converter.

26. The method of claim 24 wherein operating the first switch to electrically uncouple the secondary AC device from the set of AC terminals of the bi-directional power converter further electrically couples a primary AC device to the first set of AC terminals of the bi-directional power converter.

27. The method of claim 24 wherein operating the first switch to electrically uncouple the secondary AC device from the set of AC terminals of the bi-directional power converter further causes a physical load driven by a primary AC device to be uncoupled from the primary AC device when the secondary AC device is electrically coupled to the set of AC terminals of the bi-directional power converter and causes the physical load driven by the primary AC device to be coupled to the primary AC device when the secondary AC device is electrically uncoupled to the set of AC terminals of the bi-directional power converter.

28. The method of claim 24 wherein the power system further comprises a second switch, the method further comprising:
operating the second switch to selectively electrically reverse a polarity of a coupling of a DC device to the set of DC terminals.

29. The method of claim 24 wherein the power system further comprises a boosting circuit and a second switch, the method further comprising:
operating the second switch to selectively electrically couple and uncouple the boosting circuit between the set of DC terminals of the bi-directional power converter and a DC device coupled to the set of DC terminals.

30. The method of claim 24 wherein the power system further comprises a second switch, the method further comprising:
operating the second switch to selectively electrically couple a DC device to the set of DC terminals of the bi-directional power converter.

31. The method of claim 24 wherein the power system further comprises a second switch, the method further comprising:
operating the second switch to selectively electrically couple one of at least two DC devices to the set of DC terminals of the bi-directional power converter.

32. The method of claim 24 further comprising:
applying a set of control signals to at least some of the switching components to operate the bi-directional power converter in a boost mode.

33. The method of claim 24 further comprising:
applying a set of control signals to at least some of the switching components to operate the bi-directional power converter in a buck-boost mode.

34. A method of operating a power system, the power system comprising a bi-directional power converter, the method comprising:
electrically coupling a first AC device to the bi-directional power converter;
rectifying a charging AC current supplied by the first AC device to the bi-directional power converter to produce a charging DC current;
charging a DC device electrically coupled to the bi-directional power converter using the charging DC current;
electrically uncoupling the first AC device from the bi-directional power converter;
inverting a discharging DC current supplied by the DC device to the bi-directional power converter to produce a discharging AC current; and
supplying the discharging AC current to a second AC device.

35. The method of claim 34 wherein rectifying a charging AC current supplied by the first AC device to the bi-directional power converter to produce a charging DC current comprises rectifying at least one of a single phase and a three phase current supplied from an electrical power grid.

36. The method of claim 34 wherein rectifying a charging AC current supplied by the first AC device to the bi-directional power converter to produce a charging DC current comprises rectifying at least one of a single phase and a three phase current supplied from an electric traction motor operating in a regeneration mode.

37. The method of claim 34 wherein supplying the discharging AC current to a second AC device comprises supplying the discharging AC current to an electrical motor.

38. The method of claim 34 wherein supplying the discharging AC current to a second AC device comprises supplying the discharging AC current to an electrical power grid.

39. The method of claim 34 wherein inverting a discharging DC current supplied by the DC device to the bi-directional power converter to produce a discharging AC current comprises inverting a current received from an electrical storage device.

40. The method of claim 34 wherein inverting a discharging DC current supplied by the DC device to the bi-directional power converter to produce a discharging AC current comprises inverting a current received from a fuel cell system.

41. The method of claim 34, further comprising:
electrically uncoupling the second AC device from the bi-directional power converter when electrically coupling the first AC device to the bi-directional power converter.

42. The method of claim 34, further comprising:
physically uncoupling a load driven by the second AC device from the second AC device when electrically coupling the first AC device to the bi-directional power converter.

43. The method of claim 34, further comprising:
reducing an amount of power required from the bi-directional power converter by the second AC device when electrically coupling the first AC device to the bi-directional power converter.

44. The method of claim 34, further comprising:
selectively electrically coupling a boosting circuit between the bi-directional power converter and the DC device.

45. The method of claim 34, further comprising:
electrically coupling a boosting circuit between the bi-directional power converter and the DC device when the charging DC current is being supplied to the DC device and electrically uncoupling the boosting circuit from between the bi-directional power converter and the DC device when the discharging DC current is being supplied by the DC device.

46. The method of claim 45, further comprising:
electrically reversing a polarity of the electrical coupling between the bi-directional power converter and the DC device when electrically coupling and uncoupling the boosting circuit.
